(19) United States
(12) Patent Application Publication
(10) Pub. No.: US 2025/0140468 A1
(43) Pub. Date: May 1, 2025

(54) ELECTRONIC ELEMENT AND HIGH-FREQUENCY WINDING THEREOF

(71) Applicant: Sungrow Power Supply Co., Ltd., Hefei (CN)

(72) Inventors: Guoqing Cai, Hefei (CN); Jiacai Zhuang, Hefei (CN)

(73) Assignee: Sungrow Power Supply Co., Ltd., Hefei (CN)

(21) Appl. No.: 18/693,498

(22) PCT Filed: Jun. 14, 2022
(86) PCT No.: PCT/CN2022/098614

§ 371 Date: Mar. 19, 2024

(30) Foreign Application Priority Data
Dec. 10, 2021 (CN) 202111507593.7

(51) Int. Cl. H01F 27/28

(52) U.S. Cl. CPC H01F 27/2823

(57) ABSTRACT

An electronic element and a high-frequency winding thereof are provided. At least one power transmission line of the high-frequency winding is a multi-layer stranded wire, the multi-layer stranded wire includes at least two stacked layers of cables, and each layer of the cables includes multiple cables which are sequentially arranged; and any layer of the cables in the multi-layer stranded wire is at least stranded with an adjacent layer of cables, a cross section obtained by cutting the multi-layer stranded wire in any plane perpendicular to the lengthwise direction of the power transmission line includes cross sections of multiple layers of cables, which layers are stacked in a first direction, the cross section of each layer of the cables includes cross sections of multiple cables, which are sequentially arranged in a second direction, and the first direction is perpendicular to the second direction.

The present application claims the priority to Chinese Patent Application No. 202111507593.7, titled “ELECTRONIC ELEMENT AND HIGH-FREQUENCY WINDING THEREOF”, filed with the China National Intellectual Property Administration on Dec. 10, 2021, the entire disclosure of which is incorporated herein by reference.

### FIELD

The present application relates to the technical field of wires and cables, and in particular to an electronic element and a high-frequency winding thereof.

### BACKGROUND

In a high-frequency transformer or inductor, due to the existence of a high-frequency magnetic field thereof, eddy-current loss (skin effect and proximity effect) occurs in a wire. To reduce the eddy-current loss, copper foils and litz wires of suitable specifications are generally used for winding. At present, litz wire is widely used for windings of the transformer or inductor. However, due to the influence of processing technology of the litz wire, deformation is apt to happen during compression, and currents differ a lot in each strand of insulated wires, which leads to a high high-frequency resistance in the high-frequency winding of the high-frequency transformer or inductor.

### SUMMARY

In view of this, a first object of the present application is to provide a high-frequency winding, with its structural design the deformation of the enamel film can be effectively reduced, to reduce the high-frequency resistance. A second object of the present application is to provide an electronic element, which includes the above high-frequency winding.

To achieve the above first object, the following technical solutions are provided according to the present application.

A high-frequency winding is provided according to the present application, where
at least one power transmission line of the high-frequency winding is a multilayer stranded wire, the multilayer stranded wire includes at least two layers of cables arranged in a stacked manner, and each layer of the at least two layers of cables includes multiple cables arranged in sequence;
in the multilayer stranded wire, any layer of cables is stranded with at least one layer of cables adjacent thereto; and
a section of the multilayer stranded wire, being taken along any plane perpendicular to a longitudinal direction of the power transmission line, includes a section of the multiple layers of cables arranged in a stacked manner along a first direction, and a section of each layer of the at least two layers of cables includes multiple sections of multiple cables arranged in sequence along a second direction, where the first direction and the second direction are perpendicular to each other.

Preferably, in the high-frequency winding, the number of cables in each of the multiple layers of cables is equal.

Preferably, in the high-frequency winding, the cables are embodied as an N-level stranded wire set, where N≥2.

Preferably, in the high-frequency winding, a first-level stranded wire set of cables includes multiple insulated wires and an inner support, where the multiple insulated wires are arranged in a circumferential direction along an outer surface of the inner support.

Preferably, in the high-frequency winding, a first-level stranded wire set of the cable includes multiple insulated wires and a protective layer which wraps the multiple insulated wires.

Preferably, in the high-frequency winding, each of a first-level stranded wire set, . . . , an (N−1)th-level stranded wire set and an Nth-level stranded wire set is of a cylindrical shape in whole.

Preferably, in the high-frequency winding, the multilayer stranded wire includes one double-layer stranded wire, or, the multilayer stranded wire includes multiple double-layer stranded wires arranged in a stacked manner.

Preferably, in the high-frequency winding, the multilayer stranded wire includes multiple double-layer stranded wires arranged in a stacked manner, and at least one common-mode magnetic ring is provided for uniform distribution of currents in the multiple double-layer stranded wires.

Preferably, in the high-frequency winding, the multilayer stranded wire is formed by one double-layer stranded wire being bent and stacked for at least once.

Preferably, in the high-frequency winding, a current in the at least one power transmission line of the high-frequency winding is a high-frequency current during normal operation, and a frequency of the high-frequency current is higher than 1 kHz.

An electronic element including the high-frequency winding according to any one of the above solutions is provided.

Preferably, in the electronic element, the electronic element is a transformer, and the transformer includes at least two windings, where at least one of the at least two windings is the high-frequency winding according to any one of the above solutions.

Preferably, in the electronic element, the electronic element is an inductor, and the inductor includes at least one winding, where at least one of the at least one winding is the high-frequency winding according to any one of the above solutions.

In the high-frequency winding provided by the present application, as least one power transmission line is the multilayer stranded wire, where the shape of the multilayer stranded wire tends to be rectangular, which only requires to be compressed into a rectangular shape mildly or requires no compression before being directly used. Compared to compressing a stranded wire of a round shape into a rectangular shape in the prior art, the damage to the enamel film during compression and the deformation of the cables due to compression are reduced, which reduces the increasing of high-frequency resistance of the high-frequency winding due to deformation.

In order to achieve the above second object, an electronic element including the high-frequency winding according to any one of the above solutions is further provided according to the present application. Since the high-frequency winding has the above technical effects, the electronic element having the high-frequency winding also has the corresponding technical effects.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for those skilled in the art, other drawings may be obtained based on these drawings without any creative efforts.

FIG. 1 is a schematic view of a double-layer stranded wire according to an embodiment of the present application;

FIG. 2 is a sectional view of a double-layer stranded wire according to an embodiment of the present application;

FIG. 3 is a sectional view of a single cable according to an embodiment of the present application;

FIG. 4 is a sectional view of a double-layer stranded wire according to an embodiment of the present application;

FIG. 5 is a sectional view of a double-layer stranded wire according to another embodiment of the present application;

FIG. 6a is a sectional view of a multilayer stranded wire according to an embodiment of the present application;

FIG. 6b is a sectional view of a multilayer stranded wire according to another embodiment of the present application;

FIG. 7 is a schematic view showing one common-mode magnetic ring being provided for uniform distribution of current according to an embodiment of the present application;

FIG. 8 is a schematic view showing two common-mode magnetic rings being provided for uniform distribution of current according to an embodiment of the present application;

FIG. 9 is a schematic view of the structure of a high-frequency winding according to an embodiment of the present application;

FIG. 10 is a schematic view of a transformer according to an embodiment of the present application; and

FIG. 11 is a schematic view of an inductor according to an embodiment of the present application.

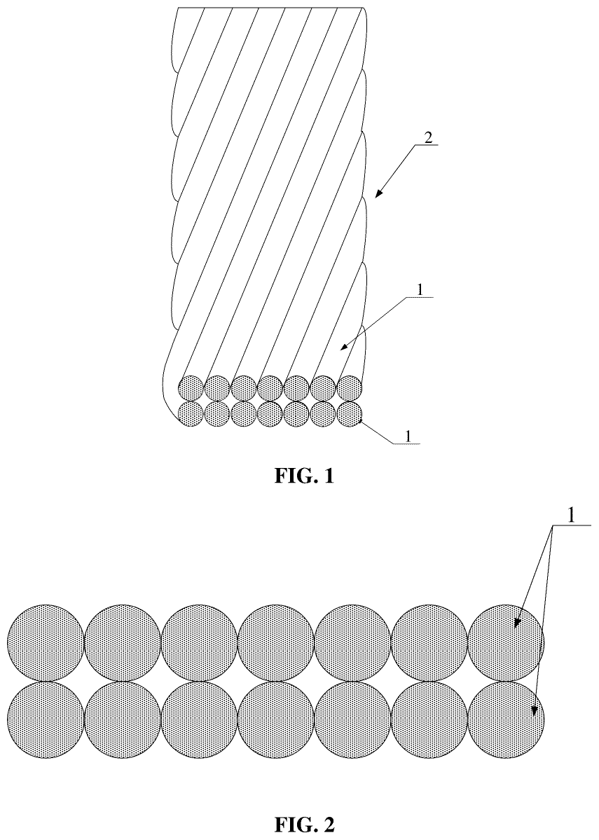

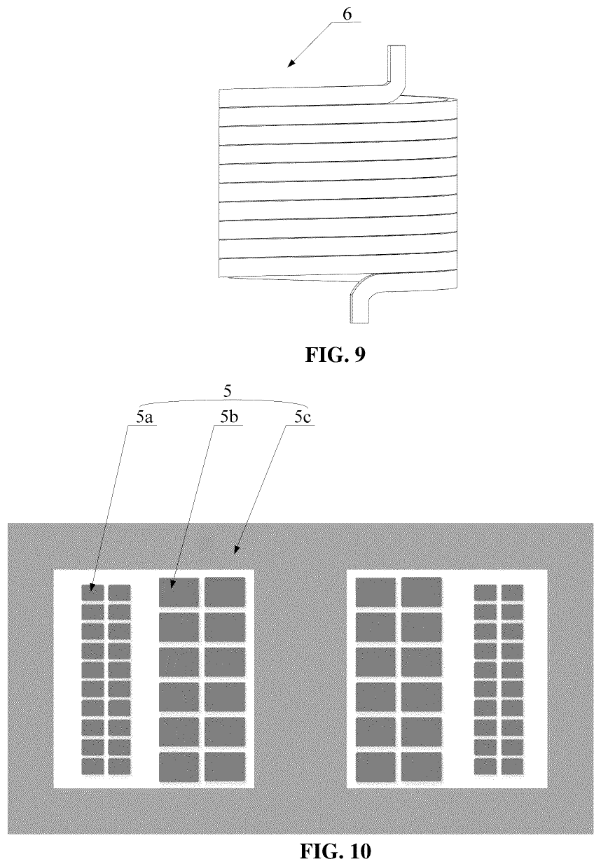

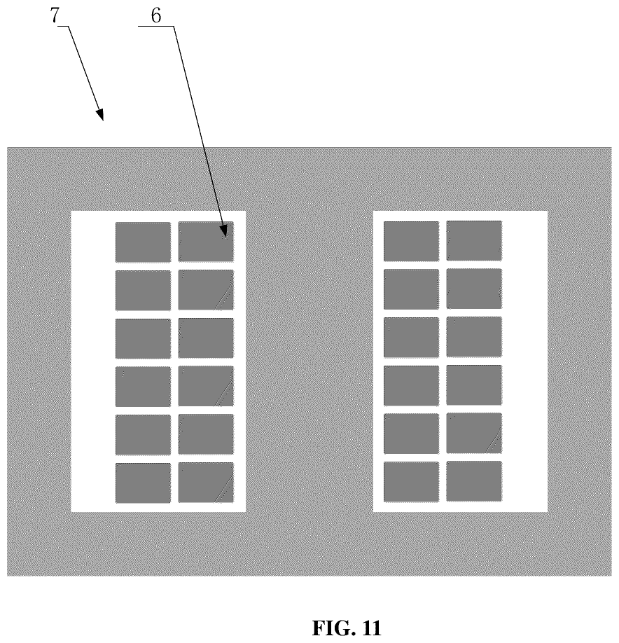

Reference numerals in FIGS. 1 to 11:

| | | | |
|---|---|---|---|
| 1 | cable, | 1a | insulated wire, |
| 1b | inner support, | 1c | protective layer, |
| 2 | double-layer stranded wire, | 3 | multilayer stranded wire, |
| 4 | common-mode magnetic ring, | 5 | transformer, |
| 5a | secondary-side winding, | 5b | primary-side winding, |
| 5c | magnetic core, | 6 | high-frequency winding, |
| 7 | inductor. | | |

### DETAILED DESCRIPTION OF THE EMBODIMENTS

Based on the prior art, a Litz (Litzendraht, Litz wire) wire is formed by stranding or braiding multiple independent insulated wires. Each of the insulated wires in an ideal litz wire has the same current flowing therein, thus has a very low high-frequency resistance. The independent insulated wires are generally enameled copper wires.

The multiple strands of insulated wires are stranded or braided to form the litz wire. In order to obtain the effect of the ideal litz wire, the stranding or braiding method is required to ensure that, each independent insulated wire is possible to appear at any position in the litz wire, and a length of each independent insulated wire is the same, which is referred to as ideal stranding or braiding. In a case that the total number of strands is relatively small, both stranding and braiding can lead to a good result. However, in a case that the number of strands is large, the stranding method is generally applied in consideration of complicacy of the process.

For a litz wire with a large number of strands, there are two solutions in general, one of which is concentric stranding, and the other is rope lay stranding. In concentric stranding, when the number of strands to be stranded is greater than 5, the structure will be divided into an inner layer and an outer layer, where sub litz-wire sets in a same layer keep changing their positions within their own layer, but will not change to another layer, which is not conducive to reducing the high-frequency resistance. The rope lay stranding refers to that, n plurality of wire sets are bundled into a wire bundle first, which is then stranded by a normal stranding method.

With the above two methods, the total number of strands of the litz wire can be increased. However, it can be seen that, the above two stranding methods can easily leads to non-uniform currents between the strands of insulated wires, causing the high-frequency resistance to be high and the loss to be increased. Moreover, the stranded insulated wire obtained by the above stranding methods are all of a cylinder-like shape, and the enamel film of the insulated wire is apt to be damaged when being compressed into a rectangular shape, which easily makes the stranded insulated wire be deformed, leading to a high-frequency resistance.

In view of the above problems, a first object of the present application is to provide a high-frequency winding, the structural design of which can effectively reduce the deformation of the enamel film to reduce the high-frequency resistance. A second object of the present application is to provide an electronic element, which includes the above high-frequency winding.

Technical solutions according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

In the description of the present application, it should be noted that the orientation or positional relationships indicated by terms such as “up”, “down”, “front”, “back”, “left”, “right” and the like are based on the orientation or positional relationships shown in the drawings, and are merely for the convenience of describing the present application and the simplification of the description, and do not indicate or imply that the device or element referred to must have a particular orientation, or be configured and operated in a particular orientation, which therefore should not be construed as a limitation to the scope of the present application. In addition, terms such as “first”, “second” and the like are merely for description, and should not be construed as indicating or implying relative importance.

As shown in FIGS. 1 to 11, the high-frequency winding provided in the present application includes one or more power transmission lines. At least one power transmission line of the high-frequency winding is a multilayer stranded wire 3. The multilayer stranded wire 3 includes at least two layers of cables 1 arranged in a stacked manner, where each layer of cables 1 includes multiple cables 1 arranged in sequence.

Any layer of cables 1 in the multilayer stranded wire 3 is at least stranded with one layer of cables 1 adjacent thereto, that is, any layer of cables 1 in the multilayer stranded wire 3 is stranded with one layer of cables 1 adjacent thereto, or, any layer of cables 1 in the multilayer stranded wire 3 is stranded with two layers of cables 1 adjacent thereto. Specifically, any layer of cables 1 of the multilayer stranded wire 3 is embodied as preset cables, two layers of cables 1 are provided adjacent to the preset cables along a first direction, and the two layers of cables 1 adjacent to the preset cables are a first layer of cables and a second layer of cables respectively, where the preset cables are stranded with both the first layer of cables and the second layer of cables; or, the preset cables are stranded with the first layer of cables; or, the preset cables are stranded with the second layer of the cables. If the preset cables are provided with one layer of cables adjacent thereto along the first direction, and the layer of cables adjacent to the preset cables is the first layer of cables, the preset cables are stranded with the first layer of cables.

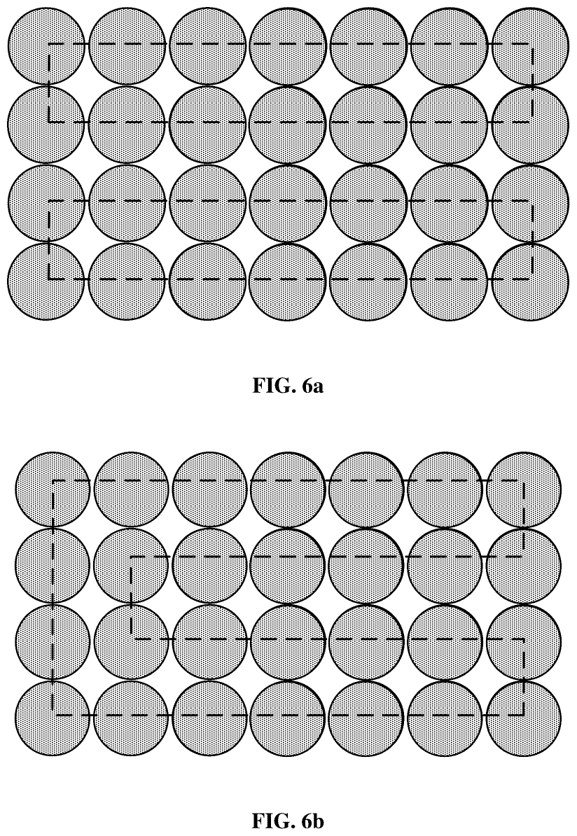

Specifically, a section of the multilayer stranded wire, being taken along any plane perpendicular to a longitudinal direction of the power transmission line, includes a section of multiple layers of cables 1 arranged in a stacked manner along the first direction, and a section of each layer of cables 1 includes multiple sections of the multiple cables 1 arranged in sequence along a second direction, where the first direction and the second direction are perpendicular to each other. As shown in FIGS. 2, 6a and 6b, FIG. 2 is a sectional view of a double-layer stranded wire 2, and FIGS. 6a and 6b are sectional views of four-layer stranded wires.

In the high-frequency winding provided by the present application, as least one power transmission line is the multilayer stranded wire 3, where the shape of the multilayer stranded wire 3 tends to be rectangular, which only requires to be compressed into a rectangular shape mildly or requires no compression before being directly used. Compared to compressing a stranded wire of a round shape into a rectangular shape in the prior art, the damage to the enamel film during compression and the deformation of the cables 1 due to compression are reduced, which reduces the increasing of high-frequency resistance of the high-frequency winding due to deformation.

In a preferred embodiment, the number of cables 1 in each of the multiple layers of cables 1 may be equal, such that the multilayer stranded wire 3 is closer to ideal stranding. Certainly, the number of cables 1 in each of the multiple layers of cables 1 may not be equal, which is not limited herein.

In a specific embodiment, the cables 1 are embodied as an N-level stranded wire set in particular, where N≥2. Specifically, the N-level stranded wire set includes a first-level stranded wire set, . . . , and an Nth-level stranded wire set, where the Nth-level stranded wire set includes multiple (N−1)th-level stranded wire sets.

The first-level stranded wire set includes multiple insulated wires 1a, and the multiple insulated wires 1a are stranded or arranged in parallel to together form the first-level stranded wire set. A second-level stranded wire set includes multiple first-level stranded wire sets.

Certainly, the cables 1 may only be one-level stranded wire set, which is not limited herein.

In a specific embodiment, the first-level stranded wire set further includes an inner support 1b, where the multiple insulated wires 1a are arranged in a circumferential direction along an outer surface of the inner support 1b. Specifically, in a sectional view of the first-level stranded wire set, which is taken along a plane perpendicular to an axis of the inner support 1b, sections of the multiple insulated wires 1a are distributed in a circumferential direction of a section of the inner support 1b. Preferably, the sections of the multiple insulated wires 1a are evenly distributed in the circumferential direction of the section of the inner support 1b, which allows an increased number of stranded sets on the premise that the ideal stranding is satisfied.

In the sectional view of the first-level stranded wire set, which is taken along the plane perpendicular to the axis of the inner support 1b, the section of the inner support 1b may be round or a regular polygon, or it can be said that the section of the inner support 1b is of a centrosymmetric shape.

In this embodiment, the inner support 1b is arranged at a center of the multiple insulated wires 1a, which makes the multiple insulated wires 1a distributed more evenly, to prevent the wires from being sunken inwards or terribly compressed by each other.

Further, the multiple insulated wires 1a of the first-level stranded wire set extend spirally respect to the inner support 1b, i.e. the multiple insulated wires 1a of the first-level stranded wire set are stranded at an outer side of the inner support 1b. As shown in FIG. 8, specifically, the multiple insulated wires 1a of the first-level stranded wire set may be stranded in a single layer at the outer side of the inner support 1b, to facilitate ideal stranding.

Or, the multiple insulated wires 1a of the first-level stranded wire set are all arranged in parallel to the axis of the inner support 1b. In this embodiment, an extension direction of the multiple insulated wires 1a of the first-level stranded wire set is the same as an extension direction of the inner support 1b.

To prevent short-circuit of the inner support 1b, the inner support 1b may be an insulating member, i.e. the material of the inner support 1b may be an insulating material. Certainly, the inner support 1b may be a metal member with insulating treatment being performed to two ends of the inner support 1b, to prevent a current from flowing through the inner support 1b which increases the high-frequency resistance.

In the consideration that the multiple first-level stranded wire sets can be stranded, the hardness of the support may not be too large, where the specific material is not limited.

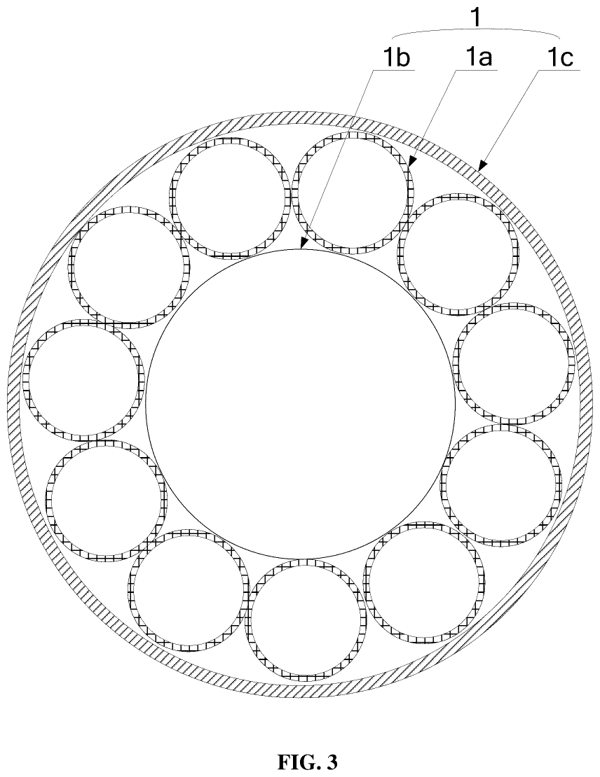

As shown in FIG. 3, in another embodiment, the first-level stranded wire set further includes a protective layer 1c wrapping the multiple insulated wires 1a. The protective layer 1c can protect the multiple insulated wires 1a, and prevent the enamel film of the multiple insulated wires 1a from being damaged during sequent stranding or compression into a rectangular shape. The protective layer 1c can reduce the extrusion friction during stranding of next several levels, provide a buffer during compression, and also reduce the probability of pinhole short-circuit.

In the above embodiments, the material of the protective layer 1c may be nylon or polyester. Certainly, according to actual situation, the protective layer 1c may be of other materials, which is not limited herein.

The Nth-level stranded wire set includes multiple (N−1)th-level stranded wire sets, where the multiple (N−1)th-level stranded wire sets are stranded. Certainly, multiple (N−2)th-level stranded wire sets of the same (N−1)th-level stranded wire set 1 may be arranged in parallel with each other, which is not limited herein.

In a specific embodiment, N=1. The cables 1 include multiple layers of first-level stranded wire sets and each layer of cables 1 includes multiple first-level stranded wire sets arranged in sequence. Specifically, if 800 strands of the insulated wires 1a are required to be stranded, a stranding method of 5*5*32 can be implemented according to the present application.

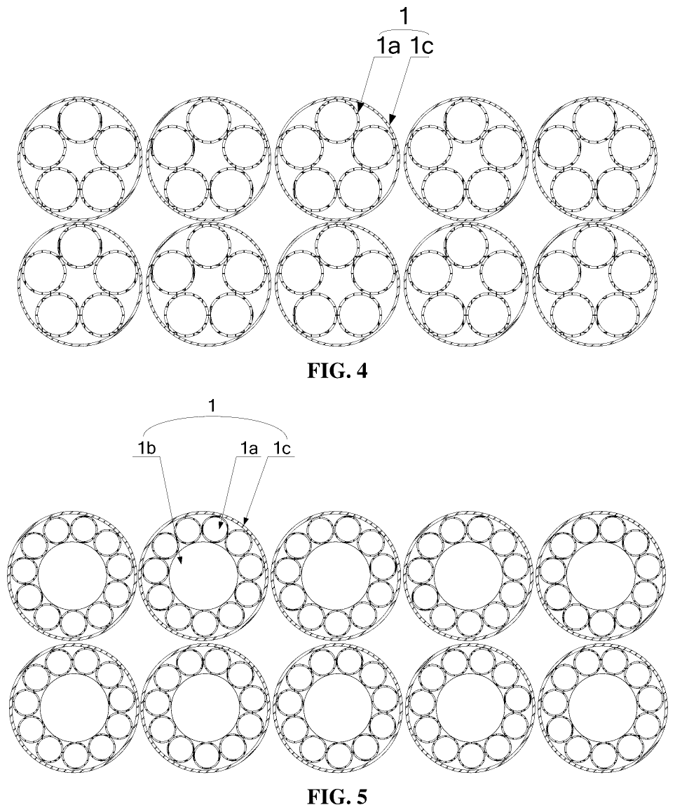

In another specific embodiment, FIGS. 4 and 5 are sectional views showing two layers of cables 1 being stranded provided by two embodiments respectively. FIG. 4 is a schematic view of a case that the first-level stranded wire set includes the protective layer 1c. FIG. 5 is a schematic view of a case that the first-level stranded wire set includes the inner support 1b and the protective layer 1c.

To facilitate stacking of the multiple layers of cables 1, each of the first-level stranded wire set, . . . , the (N−1)th-level stranded wire set and the Nth-level stranded wire set is of a cylindrical shape in whole. Certainly, any level of the stranded wire set may be rectangular or of other shapes, which is not limited herein.

The multilayer stranded wire 3 includes one double-layer stranded wire 2, or the multilayer stranded wire 3 includes multiple double-layer stranded wires 2 arranged in a stacked manner. Specifically, as shown in FIG. 2, when the multilayer stranded wire 3 includes one double-layer stranded wire 2, the multilayer stranded wire 3 includes only two layers of cables 1, and the two layers of cables 1 are stranded. When the multilayer stranded wire 3 includes the multiple double-layer stranded wires 2 arranged in a stacked manner, the multilayer stranded wire 3 includes an even number of layers of cables 1, and the number of the layers of cables 1 is equal to or larger than 4. In the multiple double-layer stranded wires 2 arranged in a stacked manner, any two adjacent double-layer stranded wires 2 are stacked in the first direction without being stranded.

As shown in FIG. 2, the double-layer stranded wire 2 includes two layers of cables 1, where each layer of cables 1 includes multiple cables 1 arranged in sequence, and the number of cables 1 in each of the multiple layers of cables 1 is equal, and where the two layers of cables 1 are stranded. A section of the double-layer stranded wire 2, taken along any plane perpendicular to a longitudinal direction of the cables 1, includes a section of the two layers of cables 1 arranged in a stacked manner along the first direction, and a section of each layer of the two layers of cables 1 includes multiple sections of the multiple cables arranged in sequence along the second direction, where the first direction and the second direction are perpendicular to each other.

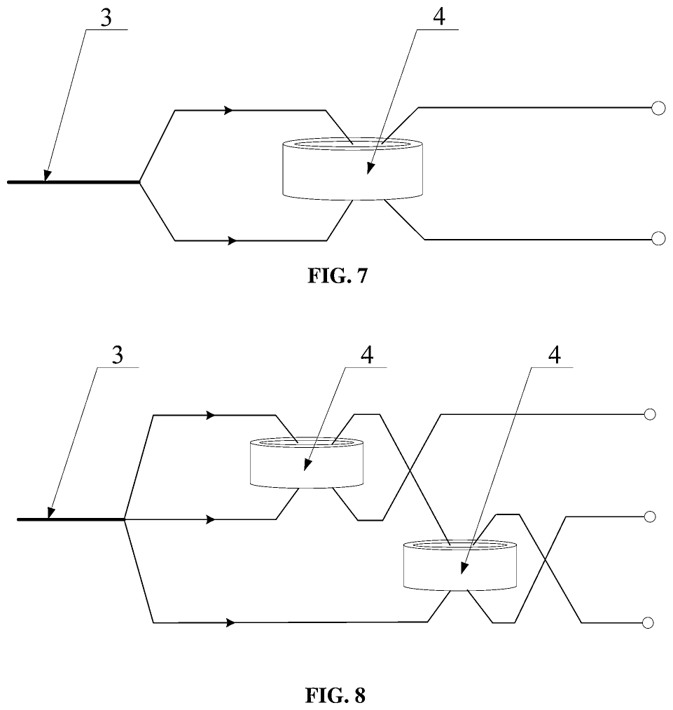

In another embodiment, when the multilayer stranded wire 3 includes the multiple double-layer stranded wires 2 arranged in a stacked manner, the multilayer stranded wire 3 includes an even number of layers of cables 1, and the number of the layers of cables 1 is equal to or larger than 4. In this embodiment, to make a current in the multiple double-layer stranded wires 2 more uniform, at least one common-mode magnetic ring 4 is provided for uniform distribution of currents in the multiple double-layer stranded wires 2. As shown in FIG. 7, when the number of the double-layer stranded wires 2 is two, the two double-layer stranded wires 2 pass through the common-mode magnetic ring 4 in opposite directions for uniform distribution of the currents. As shown in FIG. 8, when the number of the double-layer stranded wires 2 is three, two common-mode magnetic rings 4 are needed, where any two of the double-layer stranded wires 2 pass through a same common-mode magnetic ring 4 in opposite directions for uniform distribution of the currents.

In another specific embodiment, the multilayer stranded wire 3 is formed by a double-layer stranded wire 2 being bent and stacked for at least once. The double-layer stranded wire 2 is divided into multiple segments along a whole longitudinal direction and the multiple segments are arranged in a stacked manner after the double-layer stranded wire 2 being bent and stacked. Specifically, any cable 1 in the double-layer stranded wire 2 after stranding is possible to appear at any position in the multiple segments.

Preferably, a current in at least one power transmission line of the high-frequency winding 6 is a high-frequency current during normal operation, and the frequency of the high-frequency current is higher than 1 kHz. Certainly, the current in the power transmission line of the high-frequency winding 6 may be set according to actual situation, which is not limited herein.

Based on the high-frequency winding 6 according to the above embodiments, an electronic element is further provided in the present application, where the electronic element includes any one of the high-frequency windings 6 according to the above embodiments. Since the electronic element has the high-frequency winding 6 in the above embodiments, the beneficial effects of the electronic element can be referred to the above embodiments.

Specifically, the electronic element may be a transformer 5, and the transformer 5 includes at least two windings, where at least one of the windings is the high-frequency winding 6 according to any one of the above embodiments. As shown in FIG. 10, specifically, the transformer 5 includes a secondary-side winding 5a, a primary-side winding 5b and a magnetic core 5c. The secondary-side winding 5a includes multiple windings, and one or more of the multiple windings of the secondary-side winding 5a may employ the high-frequency winding 6 according to any one of the above embodiments. The primary-side winding 5b includes multiple windings, and one or more of the multiple windings of the primary-side winding 5b may employ the high-frequency winding 6 according to any one of the above embodiments. Certainly, the number of the high-frequency windings 6 in the secondary-side winding 5a and the primary-side winding 5b may be configured according to actual situation, which is not limited herein.

In addition, the electronic element may be an inductor 7, and the inductor 7 includes at least one winding, where at least one of the at least one winding employs the high-frequency winding 6 in any one of the above embodiments.

For the transformer 5 or the inductor 7 having the high-frequency winding 6 provided by any one of the above embodiments, when the electric parameters remain unchanged, the power density is higher.

Certainly, the electronic element may be an electronic converter or other devices, which is not limited herein.

The above embodiments in this specification are described in a progressive manner. Each of the embodiments is mainly focused on describing its differences from other embodiments, and references may be made among these embodiments with respect to the same or similar portions among these embodiments.

Based on the above description of the disclosed embodiments, those skilled in the art are capable of carrying out or using the present application. It is obvious for those skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A high-frequency winding, wherein
at least one power transmission line of the high-frequency winding is a multilayer stranded wire, the multilayer stranded wire comprises at least two layers of cables arranged in a stacked manner, and each layer of the at least two layers of cables comprises a plurality of cables arranged in sequence;
in the multilayer stranded wire, any layer of cables is stranded with at least one layer of cables adjacent thereto; and
a section of the multilayer stranded wire, being taken along any plane perpendicular to a longitudinal direction of the power transmission line, comprises a section of the at least two layers of cables arranged in a stacked manner along a first direction, and a section of each layer of the at least two layers of cables comprises a plurality of sections of a plurality of cables arranged in sequence along a second direction, wherein the first direction and the second direction are perpendicular to each other.

2. The high-frequency winding according to claim 1, wherein the number of cables in each of the at least two layers of cables is equal.

3. The high-frequency winding according to claim 1, wherein the at least two layers of cables are embodied as an N-level stranded wire set, wherein N≥2.

4. The high-frequency winding according to claim 3, wherein a first-level stranded wire set of cables comprises a plurality of insulated wires and an inner support, wherein the plurality of insulated wires are arranged in a circumferential direction along an outer surface of the inner support.

5. The high-frequency winding according to claim 3, wherein a first-level stranded wire set of the cables comprises a plurality of insulated wires and a protective layer wrapping the plurality of insulated wires.

6. The high-frequency winding according to claim 3, wherein each of a first-level stranded wire set, . . . , an (N−1)th-level stranded wire set and an Nth-level stranded wire set is of a cylindrical shape in whole.

7. The high-frequency winding according to claim 1, wherein the multilayer stranded wire comprises one double-layer stranded wire, or, the multilayer stranded wire comprises a plurality of double-layer stranded wires arranged in a stacked manner.

8. The high-frequency winding according to claim 1, wherein the multilayer stranded wire comprises a plurality of double-layer stranded wires arranged in a stacked manner, and at least one common-mode magnetic ring is provided for uniform distribution of currents in the plurality of double-layer stranded wires.

9. The high-frequency winding according to claim 1, wherein the multilayer stranded wire is formed by one double-layer stranded wire being bent and stacked for at least once.

10. The high-frequency winding according to claim 1, wherein a current in the at least one power transmission line of the high-frequency winding is a high-frequency current during normal operation, and a frequency of the high-frequency current is higher than 1 kHz.

11. An electronic element, comprising the high-frequency winding according to claim 1.

12. The electronic element according to claim 11, wherein the electronic element is a transformer, and the transformer comprises at least two windings, wherein at least one of the at least two windings is the high-frequency winding.

13. The electronic element according to claim 11, wherein the electronic element is an inductor, and the inductor comprises at least one winding, wherein at least one of the at least one winding is the high-frequency winding.

14. An electronic element, comprising the high-frequency winding according to claim 3.

15. An electronic element, comprising the high-frequency winding according to claim 4.

16. An electronic element, comprising the high-frequency winding according to claim 5.

17. An electronic element, comprising the high-frequency winding according to claim 6.

18. An electronic element, comprising the high-frequency winding according to claim 7.

19. An electronic element, comprising the high-frequency winding according to claim 8.

20. An electronic element, comprising the high-frequency winding according to claim 9.
